(19) United States
(12) Patent Application Publication
(10) Pub. No.: US 2023/0419221 A1
(43) Pub. Date: Dec. 28, 2023

(54) SIMULATING MODELS OF RELATIVE RISK FORECASTING IN A NETWORK SYSTEM

(71) Applicant: Truist Bank, Charlotte, NC (US)

(72) Inventors: Jason C. Sheppard, Wilson, NC (US); Jennifer Dick, Charlotte, NC (US); Mark Vasudevan, Winston-Salem, NC (US)

(73) Assignee: Truist Bank, Charlotte, NC (US)

(21) Appl. No.: 17/847,281

(22) Filed: Jun. 23, 2022

(51) Int. Cl. G06Q 10/06; G06Q 10/04

(52) U.S. Cl. CPC G06Q 10/0635; G06Q 10/04

(57) ABSTRACT

Simulated models for forecasting relative risk in a network system can be determined according to some examples. For example, a computing system can receive a set of risk data associated with a set of risk factors that are organized into a hierarchy of groupings. Each risk factor can be associated with one or more risk controls that each have a control strength value for reducing riskiness of the risk factor. The computing system can determine an inherent risk value for each grouping based on risk data associated with the grouping. The computing system can generate a risk forecasting model of residual risk for each grouping. The residual risk can be an amount of riskiness remaining after control strength values of the risk controls are applied to the inherent risk value. The computing system can output the risk forecasting model for display on a graphical user interface.

### TECHNICAL FIELD

The present disclosure relates network systems and, more particularly (although not necessarily exclusively), to simulating models of relative risk forecasting in network systems.

### BACKGROUND

Separate data systems in a network can include different types of data in different formats. Integrating data from separate systems may be an involved process that takes a significant amount of time, requires significant computing power, and is often a technically challenging process. Even data in the separate systems that is the same type may be in different formats or represented differently. When two entities, even entities that focus on the same thing, combine in some manner, often the data in the separate systems of the entities can be in different formats.

### SUMMARY

One example of the present disclosure includes a system comprising a processor and a non-transitory computer-readable memory. The non-transitory computer-readable memory can include instructions that are executable by the processor for causing the processor to perform operations. The operations can include receiving a set of risk data associated with a set of risk factors that are organized in a hierarchy of groupings from a client device. Each risk factor of the set of risk factors can be associated with one or more risk controls that each have a control strength value for reducing riskiness of the risk factor. The operations can include determining an inherent risk value for each grouping of the hierarchy of groupings based on risk data associated with the grouping. The operations can include generating a risk forecasting model of residual risk for each grouping. Residual risk can be an amount of riskiness after control strength values of the risk controls are applied to the inherent risk value. The operations can include outputting the risk forecasting model for display on a graphical user interface to the client device.

Another example of the present disclosure can include a method. The method can include receiving, by a processor, a set of risk data associated with a set of risk factors that are organized in a hierarchy of groupings from a client device. Each risk factor of the set of risk factors can be associated with one or more risk controls that each have a control strength value for reducing riskiness of the risk factor. The method can include determining, by a processor, an inherent risk value for each grouping of the hierarchy of groupings based on risk data associated with the grouping. The method can include generating, by a processor, a risk forecasting model of residual risk for each grouping. Residual risk can be an amount of riskiness after control strength values of the risk controls are applied to the inherent risk value. The method can include outputting, by the processor, the risk forecasting model for display on a graphical user interface to the client device.

Still another example of the present disclosure can include a non-transitory computer-readable medium comprising program code that is executable by a processor for causing the processor to perform operations. The operations can include receiving a set of risk data associated with a set of risk factors that are organized in a hierarchy of groupings from a client device. Each risk factor of the set of risk factors can be associated with one or more risk controls that each have a control strength value for reducing riskiness of the risk factor. The operations can include determining an inherent risk value for each grouping of the hierarchy of groupings based on risk data associated with the grouping. The operations can include generating a risk forecasting model of residual risk for each grouping. Residual risk can be an amount of riskiness after control strength values of the risk controls are applied to the inherent risk value. The operations can include outputting the risk forecasting model for display on a graphical user interface to the client device.

### BRIEF DESCRIPTION OF THE DRAWINGS

FIG. 1 is a block diagram of an example of a network system for generating a risk forecasting model according to one aspect of the present disclosure.

FIG. 2 is a block diagram of another example of a network system for generating a risk forecasting model according to one aspect of the present disclosure.

FIG. 3 is a flowchart of a process for generating a risk forecasting model for a network system according to one aspect of the present disclosure.

FIG. 4 is an example of a graphical user interface used for displaying a risk forecasting model for a network system according to one aspect of the present disclosure.

FIG. 5 is another example of a graphical user interface used for displaying a risk forecasting model for a network system according to one aspect of the present disclosure.

### DETAILED DESCRIPTION

Certain aspects and features relate to generating a risk forecasting model relating to risk factors in connection with risk management capabilities in a network system that includes multiple, distributed devices and subsystems. A risk factor can be any process, product, vulnerability, or event that may have a negative impact on an organization or system. The network system can determine relative risk for various risk factors based on risk data by organizing the risk data into a hierarchy of groupings. Each risk factor may have an associated risk management capability, also referred to herein as a risk control. A risk control may be a potential amount of control over reducing the riskiness of the risk factor. Based on the risk data, risk controls, and hierarchy, risk forecasting models of residual risk (e.g., an amount of remaining riskiness after risk controls are applied to the risk factor) can be generated for the network system.

It may be challenging to analyze large amounts of risk data from internal or external sources. The relative risk of various risk factors may be incomparable, as risk data for various risk factors may be scaled differently or may have varying levels of detail. It may also be challenging to monitor changes in risk levels over time, or to determine what can be done to mitigate specific risk factors. This may cause difficulties in relating such risk data effectively and appropriately together such that a comprehensive, but understandable, view of the relative risk for a network system of an organization can be achieved. Generating risk forecasting models by incorporating risk data and risk controls into a single risk analysis framework may require less computing power than separately analyzing individual risk factors. Additionally, generating the risk forecasting model may involve identifying risk factors that have high amounts of risk with little to no risk control, either by quantity of risk controls or effectiveness of the risk controls. Outputting the risk forecasting model may allow a user of the network system to increase security measures for the identified risk factors to reduce residual risk for the network system.

In one particular example, multiple risk factors for a network system can be aggregated into a hierarchy of groupings. Aggregating the risk factors into risk groups in a hierarchy can relate the risk factors together. Risk data associated with the risk factors can be used in determining risk calculations for each grouping in the hierarchy. For example, a collective inherent risk value can be determined for each grouping. The inherent risk value can be the level of risk for a risk factor or grouping of risk factors based on the risk data. The risk controls can be applied to the inherent risk value to determine residual risk values. Residual risk values can be estimates of a potential level of risk after one or more risk controls is applied to a risk factor or grouping of risk factors. Risk calculations can be performed on the lowest level of the hierarchy. Risk calculations for higher levels of the hierarchy can be aggregated using the risk calculations determined on lower levels.

In order to simulate residual risk values over time for the hierarchy of groupings, a risk forecasting model of residual risk can be generated. The forecasted residual risk values in the risk forecasting model can be determined by varying control strength values of the risk controls. In some examples, the control strength values may be varied according to findings associated with the risk controls. Findings can be measures of potential improvements to the control strength values of the risk controls. In some examples, the risk controls may be interrelated, and varying a control strength value for one risk control may affect the residual risk of multiple risk factors or groupings of risk factors. For example, certain types of risk controls may be interrelated. The variation of the control strength values can be based on the types of risk controls. For example, some risk control types may be more likely to gradually increase in control strength value over time, while other risk control types may be more likely to suddenly increase in control strength value and then plateau over time. For example, some risk controls may provide an improvement that reduces residual risk when implemented, but does not continue to reduce additional residual risk over time, such as implementation of two-factor authentication for user logins. In some examples, recommendations for risk controls to prioritize in order to reduce residual risk can be generated based on the risk forecasting model.

The foregoing description of certain examples, including illustrated examples, has been presented only for the purpose of illustration and description and is not intended to be exhaustive or to limit the disclosure to the precise forms disclosed. Numerous modifications, adaptations, combinations, and uses thereof are possible without departing from the scope of the disclosure.

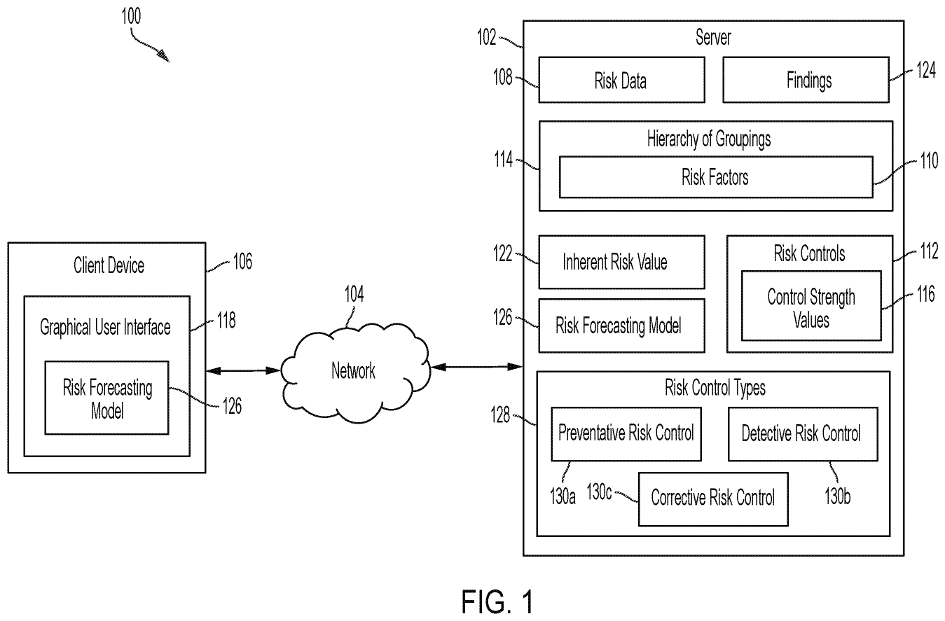

FIG. 1 is a block diagram of an example of a network system 100 for generating a risk forecasting model 126 according to one aspect of the present disclosure. Included in the network system 100 are server 102, one or more networks 104, and a client device 106. The client device 106 can transmit risk data 108 relating to various risk factors 110 for the network system 100 to the server 102 via the network 104. Examples of the client device 106 can include desktop computers, laptop computers, smart watches, and cell phones. The client device 106 can be a network device belonging to an organization for the network system 100. In some examples, the client device 106 can be a plurality of devices connected via a network.

The server 102 may be or include any type of server including, for example, a rack server, a tower server, an ultra-dense server, a super server, or the like. The server 102 may include various hardware components such as, for example, a motherboard, processing units, memory systems, hard drives, network interfaces, power supplies, etc. The server 102 may include one or more server farms, clusters, or any other appropriate arrangement or combination of computer servers. Additionally, the server 102 may act according to stored instructions located in a memory subsystem of the server 102 and may execute an operating system or other applications. In some examples, the server 102 may be a cloud-hosted system that exists on a server-less, cloud-based environment.

The server 102 may include risk factors 110 and risk controls 112. Examples of risk factors 110 can include information security, cyber security, data management, financial management, or information technology strategy. Each risk factor 110 may have one or more associated risk controls 112, which can be a measure of an amount of control for reducing riskiness of the associated risk factor 110. For example, a risk control 112 for an information security risk factor 110 can include requiring two-factor authentication to access the network system 100. The server 102 may arrange the risk factors 110 into a hierarchy of groupings 114. The hierarchy of groupings 114 may relate the risk factors 110 together into different levels. For example, risk factors 110 related to investments can be aggregated into a hierarchy 114 comprised of multiple levels of interrelated groupings. The highest level of the hierarchy 114 can be a group including all investment risks. The next level of the hierarchy 114 can divide the highest level into two groupings: a laptop investment group and a television investment group. The lowest level of the hierarchy 114 can include groupings that each include one or more risk factors 110 associated with investing in specific laptop or television products.

The server 102 may determine inherent risk values 122 for each risk factor 110. The inherent risk value 122 can be a measure of the riskiness of a risk factor 110 based on the risk data 108 alone if no risk controls 112 are applied to the risk factor 110. Inherent risk values 122 of the groupings in the hierarchy of groupings 114 can also be determined based on the risk factors 110. For example, an inherent risk value 122 for a grouping can be an average or a weighted average of the inherent risk values 122 of risk factors 110 within the grouping. Groupings that include multiple, lower level groupings can have inherent risk values 122 based on the lower level grouping inherent risk values.

The server 102 may also determine residual risk values for the risk factors 110 based on the risk data 108 and risk controls 112. For example, a residual risk value can be an estimation of the riskiness of a risk factor 110 or grouping of risk factors 110 after risk controls 112 are applied to the risk factor 110 or grouping of risk factors 110. For example, a risk factor 110 of network security can have an inherent risk value reflecting risk associated with the security of a network before any security measures are applied. Risk controls 112 for the risk factor 110 can include the various security measures, such as encryption and user authentication. The residual risk value may be a measure of the potential risk to the security of the network after the various security measures are implemented, based on the current risk data 108. Residual risk values can be used to determine areas of high risk in the network system 100. For example, a risk factor 110 with residual risk values exceeding a predetermined acceptable risk level may indicate that risk controls 112 associated with the risk factor 110 should be improved.

To simulate expected residual risk values for the risk factors 110 and the hierarchy of groupings 114, the server 102 can generate a risk forecasting model 126. Generating the risk forecasting model 126 can involve predicting variations in residual risk over time by varying control strength values 116 of risk controls 112. In some examples, the control strength values 116 can be varied according to historical patterns. For example, control strength values 116 that have been consistently increasing or decreasing over time may be predicted to continue in the same pattern. In other examples, the control strength values 116 may be varied according to findings 124 associated with the risk controls 112.

The client device 106 may transmit the findings 124 to the server 102. A finding 124 may indicate a potential improvement to a control strength value 116 of a risk control 112. For example, a risk control 112 of authenticating passwords for accessing the network system 100 can be associated with a finding 124 related to improving the security of the authentication system. The finding 124 can be a planned upgrade via a two-factor authentication system at a particular time. In this example, the control strength value 116 for the risk control 112 can be varied based on the finding 124 by significantly increasing the control strength value 116 at the particular time. The change in control strength value 116 may remain constant after the particular time unless the control strength value 116 is projected to increase for other reasons.

For example, another finding 124 can be an update to the authentication system that includes a trained machine learning model, such as a neural network, for detecting bot attacks to the network system 100. The machine learning model may continually improve in detection of the bot attacks over time. Therefore, the control strength value 116 of the risk control 112 may be projected to increase over time for the risk forecasting model 126. The control strength values 116 can also be varied based on the risk control type 128. Examples of risk control types 128 can include preventative risk controls 130a, detective risk controls 130b, and corrective risk controls 130c. The preventative risk controls 130a can be used to prevent risky events in the network system 100, such as hacking attempts. Detective risk controls 130b can be used to detect risks in the network system 100, such as analyzing code to find security vulnerabilities. Corrective risk controls 130c can be implemented in response to a materialization of risk events, such as containing security breaches after a successful hacking attempt. In some examples, because corrective risk controls 130c are implemented after a risk incident, generating the risk forecasting model 126 may involve projecting an increase in control strength values 116 of corrective risk controls 130c based on low projected control strength values 116 for preventative risk controls 130a.

The control strength values 116 for risk controls 112 may be interrelated in further ways. For example, some risk controls 112 may be independent risk controls. Other risk controls 112 may have control strength values 116 that vary in response to variations in control strength values 116 of other risk controls 112. Additionally, multiple risk factors 110 may each be associated with a same risk control 112. Varying the control strength value 116 of one interdependent risk control 112 may result in significant impacts to residual risk in the risk forecasting model 126. In some examples, the server 102 may identify a particular risk control 112 that may be associated with multiple other risk factors 110 and risk controls 112. The server 102 may generate the risk forecasting model 126 by varying the control strength values 116 for the particular risk control 112. The server 102 can output the risk forecasting model 126 as a graphical user interface 118 to the client device 106. In some examples, the risk forecasting model 126 can include graphs depicting the residual risk or control strength values 116 over time. Additionally, the risk forecasting model 126 can include recommendations for risk controls 112 to prioritize.

Although certain components are shown in FIG. 1, other suitable, compatible, network hardware components and network architecture designs may be implemented in various embodiments to support communication between the client device 106 and the server 102. Such communication network(s) may be any type of network that can support data communications using any of a variety of commercially-available protocols, including, without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), Bluetooth®, Near Field Communication (NFC), and the like. Merely by way of example, the network(s) connecting the client device 106 and server 102 in FIG. 1 may be local area networks (LANs), such as one based on Ethernet, Token-Ring or the like. Such network(s) also may be wide-area networks, such as the Internet, or may include financial/banking networks, telecommunication networks such as a public switched telephone networks (PSTNs), cellular or other wireless networks, satellite networks, television/cable networks, or virtual networks such as an intranet or an extranet. Infrared and wireless networks (e.g., using the Institute of Electrical and Electronics (IEEE) 802.11 protocol suite or other wireless protocols) also may be included in these communication networks.

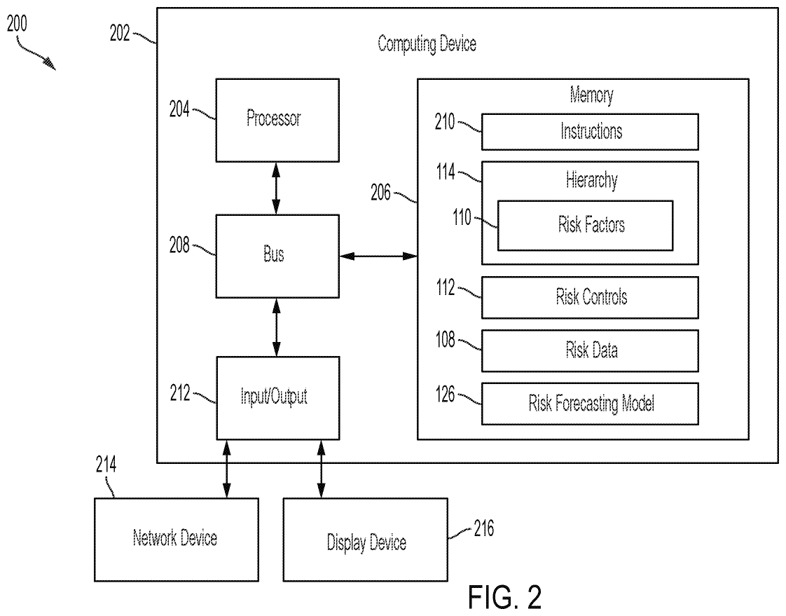

FIG. 2 is a block diagram of another example of a network system 200 for generating a risk forecasting model 126 according to one aspect of the present disclosure. The computing device 202 can include a processor 204, a memory 206, a bus 208, and an input/output 212. A display device 216 and network device 214 can be connected to the input/output 212. In some examples, the components shown in FIG. 2 may be integrated into a single structure. For example, the components can be within a single housing. In other examples, the components shown in FIG. 2 can be distributed (e.g., in separate housings) and in electrical communication with each other.

The processor 204 may execute one or more operations for implementing various examples and embodiments described herein. The processor 204 can execute instructions 210 stored in the memory 206 to perform the operations. The processor 204 can include one processing device or multiple processing devices. Non-limiting examples of the processor 204 include a Field-Programmable Gate Array (“FPGA”), an application-specific integrated circuit (“ASIC”), a microprocessor, etc.

The processor 204 may be communicatively coupled to the memory 206 via the bus 208. The non-volatile memory 206 may include any type of memory device that retains stored information when powered off. Non-limiting examples of the memory 206 include electrically erasable and programmable read-only memory (“EEPROM”), flash memory, or any other type of non-volatile memory. In some examples, at least some of the memory 206 may include a medium from which the processor 204 can read instructions 210. A computer-readable medium may include electronic, optical, magnetic, or other storage devices capable of providing the processor 204 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor may read instructions 210. The instructions 210 may include processor-specific instructions generated by a compiler or an interpreter from code written in any suitable computer-programming language, including, for example, C, C++, C#, etc.

The input/output 212 may interface other network devices or network-capable devices to analyze and receive information related to risk data 108. Information received from the input/output may be sent to the memory 206 via the bus 208. The memory 206 can store any information received from the input/output 212.

The memory 206 may include instructions 210 for receiving risk data 108 from the client device 106 from the network device 214 relating to risk factors 110 for the network system 200. The risk factors 110 may be organized into a hierarchy 114, and each risk factor 110 may be associated with one or more risk controls 112 that can reduce a riskiness of the risk factor 110. The instructions 210 may cause the computing device 202 to determine a risk forecasting model 126 based on the risk data 108, the hierarchy 114, and the risk controls 112. The instructions 210 can additionally cause the computing device 202 to output the risk forecasting model 126 to the display device 216 via the input/output 212.

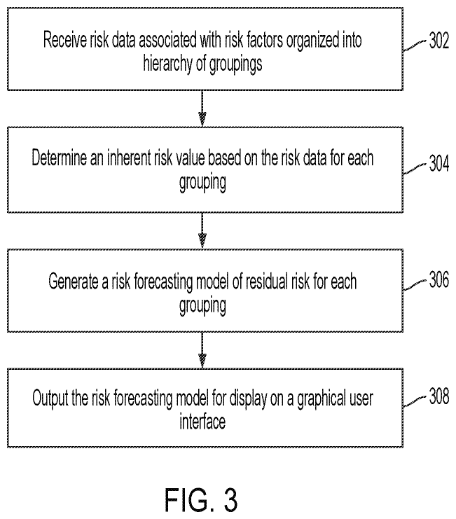

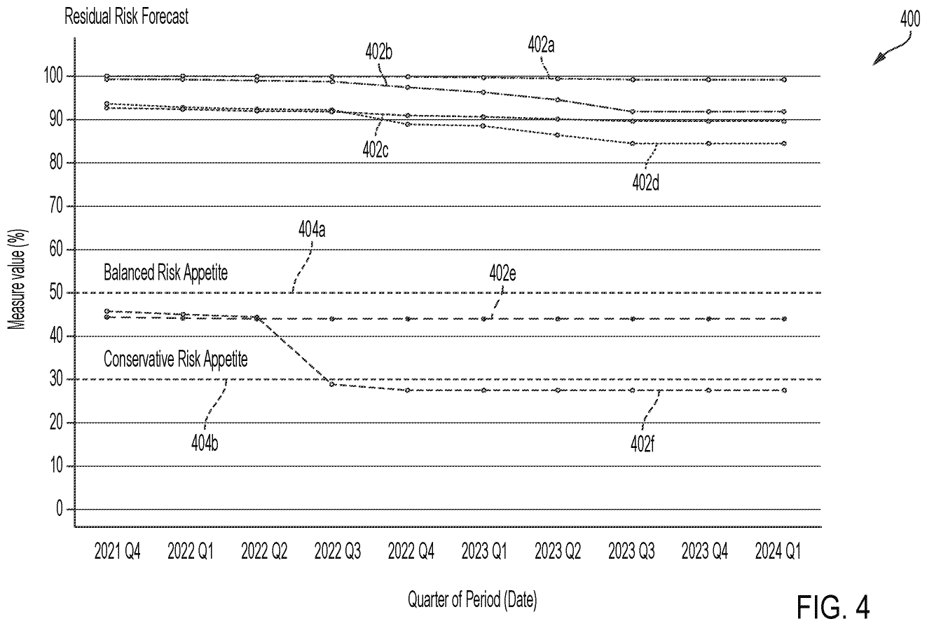

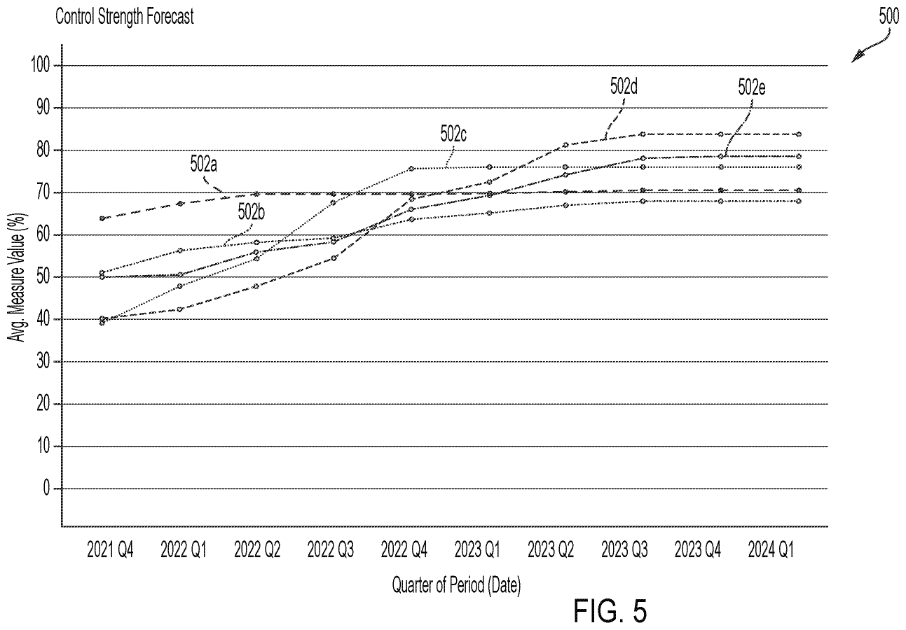

In some examples, the processor 204 can implement some or all of the steps shown in FIG. 3. Other examples may involve more steps, fewer steps, different steps, or a different order of the steps than is shown in FIG. 3. The steps of FIG. 3 are described below with reference to components described above with regard to FIGS. 1-2. Additionally, the components of FIGS. 4-5 are described with reference to the components and steps of FIGS. 1-3.

At block 302, the processor 204 can receive risk data 108 associated with risk factors 110 organized into a hierarchy of groupings 114. The risk data 108 can indicate a current level of risk for associated risk factors 110. Each risk factor 110 may be associated with one or more risk controls 112 that can be applied to the risk factor 110 for reducing riskiness. At block 304, the processor 204 can determine an inherent risk value 122 based on the risk data 108 for each grouping within the hierarchy of groupings 114. The inherent risk value 122 can be the riskiness of the risk factor 110 or grouping if no risk controls 112 are applied. A residual risk value can be the riskiness of the risk factor 110 or grouping if associated risk controls 112 are applied.

At block 306, the processor 204 can generate a risk forecasting model 126 of residual risk for each grouping within the hierarchy of groupings 114. The risk forecasting model 126 may produce predictions of residual risk for the risk factors 110 or groupings of risk factors 110. In some examples, the processor 204 may generate the risk forecasting model 126 by varying control strength values 116 of the risk controls 112. In some examples, some risk controls 112 may be interrelated with one another. Therefore, varying the control strength value 116 of a first risk control 112 may cause a change to a control strength value 116 of a second risk control 112. Additionally, or alternatively, the risk controls 112 may be interrelated with the risk factors 110. For example, one risk control 112 can be associated with two or more risk factors 110. Varying a control strength value 116 of the risk control 112 may affect residual risk forecasting for multiple risk factors 110. In some examples, the processor 204 may generate recommendations for increasing the control strength value 116 of particular risk controls 112 based on the risk forecasting model 126.

At block 308, the processor 204 can output the risk forecasting model 126 for display on a graphical user interface 118. For example, as depicted in FIG. 4, the processor 204 can generate a first graph 400 of a forecasted residual risk value for each grouping 402 of the hierarchy of groupings 114 over time based on the risk forecasting model 126. The first graph 400 can display the forecasted residual risk values over time for groupings 402a-f, although more or less groupings 402 can also be depicted. In some examples, the first graph 400 may include acceptable risk levels 404, or risk appetite, represented by dashed lines. The acceptable risk levels can represent a target amount of residual risk for a particular risk factor 110. For example, the first graph 400 can include a balanced acceptable risk level 404a that is higher than a conservative acceptable risk level 404b. The first graph 400 can be output for display on a graphical user interface 118.

Returning now to FIG. 3, in some examples the processor 204 may generate a second graph of forecasted control strength values 116 for the risk controls 112 for each grouping of the hierarchy of groupings 114 over time. For example, FIG. 5 is another example of a graphical user interface used for displaying a risk forecasting model 126 for a network system 100 according to one aspect of the present disclosure. As depicted in FIG. 5, a second graph 500 can include forecasted control strength values 116 for risk controls 502a-e, although more or less risk controls 502 can be depicted. In some examples, control strength values for the risk controls 502a-e may plateau over time unless additional findings are introduced.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processor; and
a non-transitory computer-readable memory comprising instructions that are executable by the processor for causing the processor to:
receive, from a client device, a set of risk data associated with a set of risk factors that are organized in a hierarchy of groupings, each risk factor of the set of risk factors being associated with one or more risk controls that each have a control strength value for reducing riskiness of the risk factor;
determine an inherent risk value for each grouping of the hierarchy of groupings based on risk data associated with the grouping;
generate a risk forecasting model of residual risk for each grouping, residual risk being an amount of riskiness after control strength values of the risk controls are applied to the inherent risk value; and
output, to the client device, the risk forecasting model for display on a graphical user interface.

2. The system of claim 1, wherein the memory further comprises instructions that are executable by the processor for causing the processor to generate the risk forecasting model by varying the control strength value for each risk control.

3. The system of claim 2, wherein the memory further comprises instructions that are executable by the processor for causing the processor to vary the control strength values by:
receiving, from the client device, a set of findings associated with the one or more risk controls, each finding of the set of findings indicating a potential improvement to the control strength value of an associated risk control; and
varying the control strength values based on the set of findings.

4. The system of claim 1, wherein the memory further comprises instructions that are executable by the processor for causing the processor to generate the risk forecasting model by:
determining an interrelationship between the one or more risk controls based on a risk control type for the one or more risk controls; and
generating the risk forecasting model based on the interrelationship.

5. The system of claim 4, wherein the risk control type comprises a preventative risk control type, a detective risk control type, and a corrective risk control type.

6. The system of claim 1, wherein the memory further comprises instructions that are executable by the processor for causing the processor to output the risk forecasting model by:
generating, based on the risk forecasting model, a first graph of a projected residual risk value for each grouping of the hierarchy of groupings over time;
generating, based on the risk forecasting model, a second graph of a projected control strength value for the risk controls for each grouping of the hierarchy of groupings over time; and
outputting the first graph of the projected residual risk value and the second graph of the projected control strength value for display on the graphical user interface.

7. The system of claim 1, wherein a risk control of the one or more risk controls is associated with at least two risk factors.

8. A method comprising:
receiving, by a processor, a set of risk data associated with a set of risk factors that are organized in a hierarchy of groupings from a client device, each risk factor of the set of risk factors being associated with one or more risk controls that each have a control strength value for reducing riskiness of the risk factor;
determining, by the processor, an inherent risk value for each grouping of the hierarchy of groupings based on risk data associated with the grouping;
generating, by the processor, a risk forecasting model of residual risk for each grouping, residual risk being an amount of riskiness after control strength values of the risk controls are applied to the inherent risk value; and
outputting, by the processor, the risk forecasting model for display on a graphical user interface to the client device.

9. The method of claim 8, wherein generating the risk forecasting model further comprises varying the control strength value for each risk control.

10. The method of claim 9, wherein varying the control strength values further comprises:
receiving, from the client device, a set of findings associated with the one or more risk controls, each finding of the set of findings indicating a potential improvement to the control strength value of an associated risk control; and
varying the control strength values based on the set of findings.

11. The method of claim 8, wherein generating the risk forecasting model further comprises:
determining an interrelationship between the one or more risk controls based on a risk control type for the one or more risk controls; and
generating the risk forecasting model based on the interrelationship.

12. The method of claim 11, wherein the risk control type comprises a preventative risk control type, a detective risk control type, and a corrective risk control type.

13. The method of claim 8, wherein outputting the risk forecasting model further comprises:
generating, based on the risk forecasting model, a first graph of a projected residual risk value for each grouping of the hierarchy of groupings over time;
generating, based on the risk forecasting model, a second graph of a projected control strength value for the risk controls for each grouping of the hierarchy of groupings over time; and
outputting the first graph of the projected residual risk value and the second graph of the projected control strength value for display on the graphical user interface.

14. The method of claim 8, wherein a risk control of the one or more risk controls is associated with at least two risk factors.

15. A non-transitory computer-readable medium comprising program code that is executable by a processor for causing the processor to:
receive, from a client device, a set of risk data associated with a set of risk factors that are organized in a hierarchy of groupings, each risk factor of the set of risk factors being associated with one or more risk controls that each have a control strength value for reducing riskiness of the risk factor;
determine an inherent risk value for each grouping of the hierarchy of groupings based on risk data associated with the grouping;
generate a risk forecasting model of residual risk for each grouping, residual risk being an amount of riskiness after control strength values of the risk controls are applied to the inherent risk value; and
output, to the client device, the risk forecasting model for display on a graphical user interface.

16. The non-transitory computer-readable medium of claim 15, wherein the program code is further executable by the processor for causing the processor to generate the risk forecasting model by varying the control strength value for each risk control.

17. The non-transitory computer-readable medium of claim 16, wherein the program code is further executable by the processor for causing the processor to vary the control strength values by:
receiving, from the client device, a set of findings associated with the one or more risk controls, each finding of the set of findings indicating a potential improvement to the control strength value of an associated risk control; and
varying the control strength values based on the set of findings.

18. The non-transitory computer-readable medium of claim 15, wherein the program code is further executable by the processor for causing the processor to generate the risk forecasting model by:
determining an interrelationship between the one or more risk controls based on a risk control type for the one or more risk controls; and
generating the risk forecasting model based on the interrelationship.

19. The non-transitory computer-readable medium of claim 18, wherein the risk control type comprises a preventative risk control type, a detective risk control type, and a corrective risk control type.

20. The non-transitory computer-readable medium of claim 15, wherein the program code is further executable by the processor for causing the processor to output the risk forecasting model by:
generating, based on the risk forecasting model, a first graph of a projected residual risk value for each grouping of the hierarchy of groupings over time;
generating, based on the risk forecasting model, a second graph of a projected control strength value for the risk controls for each grouping of the hierarchy of groupings over time; and
outputting the first graph of the projected residual risk value and the second graph of the projected control strength value for display on the graphical user interface.
